(19) United States
(12) Patent Application Publication
(10) Pub. No.: US 2005/0036691 A1
(43) Pub. Date: Feb. 17, 2005

(54) Method and system for using structure tensors to detect lung nodules and colon polyps

(76) Inventor: Pascal Cathier, Exton, PA (US)

Correspondence Address: Siemens Corporation;Intellectual Property Department, 170 Wood Avenue South, Iselin, NJ, 08830, US

(21) Appl. No.: 10/915,047

(22) Filed: Aug. 10, 2004

Related U.S. Application Data
(60) Provisional application No. 60/494,647, filed on Aug. 13, 2003.

(51) Int. Cl. G06K 9/46; G06K 9/36

(52) U.S. Cl. 382/203; 382/286

(57) ABSTRACT

A method of identifying spherical objects in a digital image is provided. The image comprises a plurality of 3D surface points. The method includes computing, at each point in a domain of the image, a gradient of the image; computing an elementary structure tensor at each point in the domain of the image; determining a structure tensor for each point in the domain of the image; finding the eigenvalues of the structure tensors; and calculating an isotropy measure for each structure tensor, wherein said isotropy measure is defined by a ratio of a smallest eigenvalue of said structured tensor by a largest eigenvalue of said structure tensor, wherein a spherical object correspond to an isotropy measure equal to unity.

### CROSS REFERENCE TO RELATED UNITED STATES APPLICATIONS

This application claims priority from “Use of structure tensor for lung nodule and colon polyp detection”, U.S. Provisional Application No. 60/494,647 of Pascal Cathier, filed Aug. 13, 2003, the contents of which are incorporated herein by reference.

### BACKGROUND OF THE INVENTION

The diagnostically superior information available from data acquired from current imaging systems enables the detection of potential problems at earlier and more treatable stages. Given the vast quantity of detailed data acquirable from imaging systems, various algorithms must be developed to efficiently and accurately process image data. With the aid of computers, advances in image processing are generally performed on digital or digitized images.

Digital acquisition systems for creating digital images include digital X-ray film radiography, computed tomography (“CT”) imaging, magnetic resonance imaging (“MRI”), ultrasound (“US”) and nuclear medicine imaging techniques, such as positron emission tomography (“PET”) and single photon emission computed tomography (“SPECT”). Digital images can also be created from analog images by, for example, scanning analog images, such as typical x-rays, into a digitized form. However, the large amount of data in digital images is generally difficult and tedious for a human, such as a physician, to interpret without additional aid. Computer-aided diagnosis (“CAD”) systems play a critical role in aiding the human, especially in the visualization, segmentation, detection, registration, and reporting of medical pathologies.

Digital images are created from an array of numerical values representing a property (such as a grey scale value or magnetic field strength) associable with an anatomical location points referenced by a particular array location. The set of anatomical location points comprises the domain of the image. In 2-D digital images, or slice sections, the discrete array locations are termed pixels. Three-dimensional digital images can be constructed from stacked slice sections through various construction techniques known in the art. The 3-D images are made up of discrete volume elements, also referred to as voxels, composed of pixels from the 2-D images. The pixel or voxel properties can be processed to ascertain various properties about the anatomy of a patient associated with such pixels or voxels.

Once anatomical regions and structures are constructed and evaluated by analyzing pixels and/or voxels, subsequent processing and analysis exploiting regional characteristics and features can be applied to relevant areas, thus improving both accuracy and efficiency of the imaging system.

One of the more critical CAD tasks includes the screening and early detection of various types of cancer from a volume data (e.g., a CT volume data). For instance, lung cancer is the leading cause of deaths among all cancers in the United States and around the world. A patient diagnosed with lung cancer has an average five-year survival rate of only 14%. On the other hand, if lung cancer is diagnosed in stage I, the patient's expected five-year survival rate dramatically increases to between 60 and 70 percent. Other cancers, such as colon cancer, have also shown a decrease in mortality rates resulting from the early detection and removal of cancerous tumors. Pathologies are typically spherical or hemispherical in geometric shape. In many cases, these sphere-like pathologies are attached to linear or piece-wise linear surfaces. Unfortunately, existing methods generally do not detect characteristic symptoms of various cancers until the advanced stages of the disease. Therefore, a primary goal in advancing preventive cancer screening is to provide for earlier detection of the characteristic symptoms.

### SUMMARY OF THE INVENTION

In one aspect of the invention, a method of identifying spherical objects in a digital image is provided. The image comprises a plurality of 3D surface points. The method includes computing, at each point in a domain of the image, a gradient of the image; computing an elementary structure tensor at each point in the domain of the image; determining a structure tensor for each point in the domain of the image; finding the eigenvalues of the structure tensors; and calculating an isotropy measure for each structure tensor, wherein said isotropy measure is defined by a ratio of a smallest eigenvalue of said structured tensor by a largest eigenvalue of said structure tensor, wherein a spherical object correspond to an isotropy measure equal to unity.

In another aspect of the invention, a program storage device readable by a computer, tangibly embodying a program of instructions executable by the computer to perform the method steps for identifying spherical objects in a digital image, is provided. The image comprises a plurality of intensity values corresponding to a domain of points in a 3D space. The method includes computing, at each point in the domain, a gradient of the image; computing an elementary structure tensor at each point in the domain of the image; determining a structure tensor for each point in the domain of the image; finding the eigenvalues of the structure tensors; and calculating an isotropy measure defined by dividing a smallest eigenvalue by a largest eigenvalue, wherein the isotropy measure for a spherical object is equal to unity.

In a further aspect of the invention, a method of identifying spherical objects in a digital image, wherein the image comprises a plurality of intensities corresponding to a domain of points in a 3D space,is provided. The method includes convolving the image with a derivative of a Gaussian kernel G of standard deviation σ_{G} to compute a gradient of the image at each point of the image, wherein σ_{G} is small relative to the size of the image, multiplying the gradient for each point of the image with its transpose to compute an elementary structure tensor, convolving the elementary structure tensor for each point with a Gaussian kernel of standard deviation σ_{T} to determine a structure tensor, wherein σ_{T} corresponds to the size of the object being sought, performing a Householder QL decomposition of each structure tensor to find its eigenvalues, and calculating an isotropy measure for each structure tensor. The isotropy measure is defined by a ratio of a smallest eigenvalue of the structured tensor to a largest eigenvalue of the structure tensor, where a spherical object corresponds to an isotropy measure equal to unity.

For the chest, one may be interested in detecting nodules, that appear as white spheres or half-spheres inside the dark lung region. For the colon, one may be interested in detecting polyps, which appear as round structures attached to the colon. Methods utilizing the structure tensor can be applied to a wide range of imaging modalities, including computerized tomography (CT), magnetic resonance (MR), ultrasound (US), and positron emission tomography (PET). In another aspect, these methods can also be used to detect holes, in a symmetrical way.

### BRIEF DESCRIPTION OF THE DRAWINGS

FIG. 1 depicts a flow chart of a preferred method of the invention.

FIG. 2 depicts a structure tensor along a wall of a volumetric image.

FIG. 3 depicts a structure tensor centered on a polyp.

FIG. 4 depicts an exemplary computer system for implementing a preferred embodiment of the invention.

### DETAILED DESCRIPTION OF THE PREFERRED EMBODIMENT

Illustrative embodiments of the invention are described below. In the interest of clarity, not all features of an actual implementation are described in this specification. It will of course be appreciated that in the development of any such actual embodiment, numerous implementation-specific decisions must be made to achieve the developers' specific goals, such as compliance with system-related and business-related constraints, which will vary from one implementation to another. Moreover, it will be appreciated that such a development effort might be complex and time-consuming, but would nevertheless be a routine undertaking for those of ordinary skill in the art having the benefit of this disclosure.

While the invention is susceptible to various modifications and alternative forms, specific embodiments thereof have been shown by way of example in the drawings and are herein described in detail. It should be understood, however, that the description herein of specific embodiments is not intended to limit the invention to the particular forms disclosed, but on the contrary, the intention is to cover all modifications, equivalents, and alternatives falling within the spirit and scope of the invention as defined by the appended claims.

The present invention provides for systems and methods capable of effective and accurate nodule detection from 2-D and 3-D digital images, particularly thoracic images. Although an image can be thought of as a function from R³ to R, the methods of the inventions are not limited to such images, and can be applied to images of any dimension, e.g. a 2-D picture or a 3-D volume. The present invention is preferably performed on a computer system, such as a Pentium®-class personal computer, running computer software that implements the algorithm of the present invention. The computer includes a processor, a memory and various input/output means. A series of digital images representative of a thoracic volume are input to the computer. The terms “digital” and “digitized” as used herein will refer to images or volumes, as appropriate, in a digital or digitized format acquired via a digital acquisition system or via conversion from an analog image.

The methods and systems disclosed herein can be adapted to organs or anatomical regions including, without limitation, the heart, brain, spinal, colon, liver and kidney systems. The software application and algorithm disclosed herein can employ 2-D and 3-D renderings and images of an organ or organ system. For illustrative purposes, lung and colon systems are described. However, it should be understood that the method can be applied to any of a variety of other applications known to those skilled in the art.

Prior to computing a structure tensor, an image can be pre-processed, e.g. to enhance the overall outcome of the process. This is helpful in locating a structure of interest for further analysis, and for the initial centering of the Gaussian kernels described below. High accuracy of algorithms is crucial for successful nodule detection, and preprocessing generally reduces the complexity of the domain of the function to be estimated. Preprocessing is generally more effective when it is based on known characteristics of what is being imaged. For example, a natural lung image should be spatially smooth and strictly positive in amplitude. Examples of preprocessing techniques include various smoothing, morphological and regularization techniques.

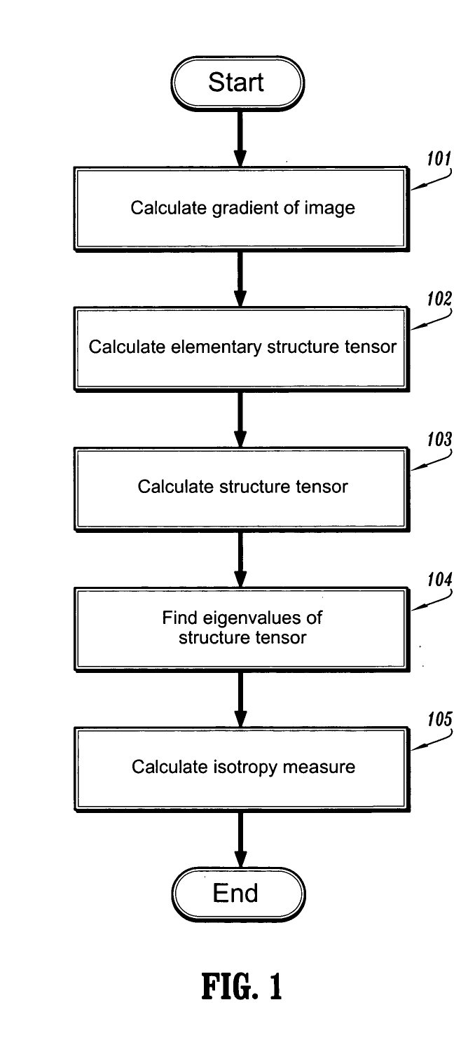

In a preferred embodiment of the invention, an image can be analyzed by measuring the isotropy of its structure tensor in order to identify spherical objects. Referring now to FIG. 1, the gradient of an image is a 3D vector formed of the image partial derivatives along the canonical axes:

$$∇ I = {[ \frac{\partial I}{\partial x} , \frac{\partial I}{\partial y} , \frac{\partial I}{\partial z} ]}^{T}$$

In practice, an image is only sampled at discrete points, and is subject to noise. In a preferred embodiment, at step 101, a gradient of an image can be estimated at each point in the domain of the image by convolving the image with a Gaussian derivative:

$$\frac{\partial I}{\partial x} \approx \frac{\partial G}{\partial x} * I ,$$

where G is a discrete normalized, D-dimensional Gaussian kernel of standard deviation σ_{G},

$$G ( x ) = \frac{1}{{( \sqrt{2 π} {σ}_{G} )}^{D}} exp ( - \frac{{x}^{2}}{2 {σ}_{G}^{2}} ) ,$$

and the operator * is a convolution. The standard deviation is typically rather small as compared to the overall size of the image, e.g. 3 voxels maximum.

An elementary structure tensor can be defined at step 102 as a 3×3 matrix obtained from the image by multiplying the gradient of the image with its transpose:
T¹=∇I.∇I^{T}

The Structure Tensor is a 3×3 matrix that can be derived by convolving at step 103 the elementary structure tensors with a spatial filter whose size corresponds to an object being sought. A preferred spatial filter is a Gaussian kernel:
T=G_{σ}*T¹.
Here, sigma can be quite big and is loosely related to the size of the object sought. Other convolution kernels could be used, but the Gaussian kernel is the preferred one. The 3 eigenvalues of the Structure Tensor can be computed at step 104 by any suitable technique known in the art. One such technique is the Householder QL decomposition.

The isotropy of the image can be derived by dividing at step 105 the smallest eigenvalue by the largest one. This isotropy measure is equal to one if all eigenvalues are equal, i.e. if the structure tensor is spherical and thus perfectly isotropic. It is less than one in all other situations. Isotropic regions are then extracted by keeping locations where the isotropy is larger than some threshold.

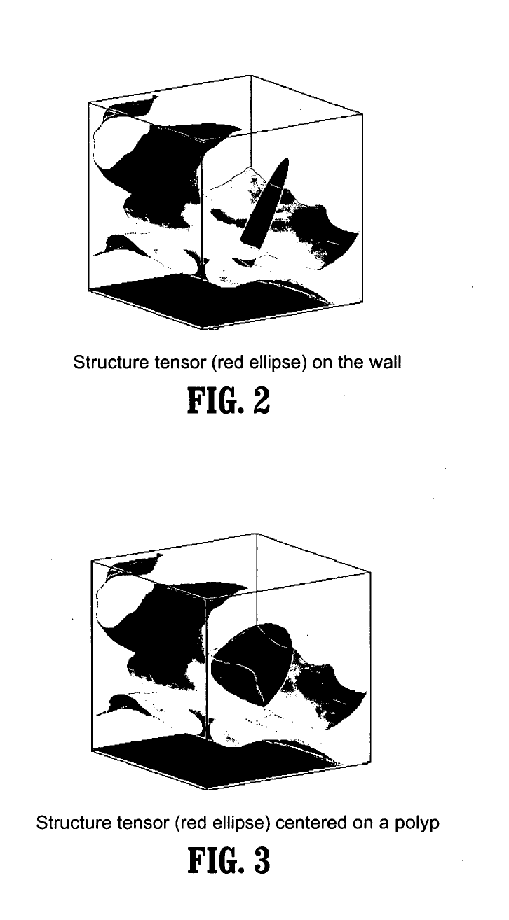

This technique can be applied to detect spherical structures. Examples of such structures include lung nodules and colon polyps, though this embodiment of the invention is not restricted to only these structures. The isotropy measure can discriminate between these structures and normal structures such as lung or colon walls that are not isotropic, as depicted in FIGS. 2 and 3. Furthermore, the methods presented herein can be used to detect holes in a structure, for a hole is a region of the image represented by low intensity values, as opposed to the high intensity values that characterize polyps or nodules.

It is to be understood that the present invention can be implemented in various forms of hardware, software, firmware, special purpose processes, or a combination thereof. In one embodiment, the present invention can be implemented in software as an application program tangible embodied on a computer readable program storage device. The application program can be uploaded to, and executed by, a machine comprising any suitable architecture.

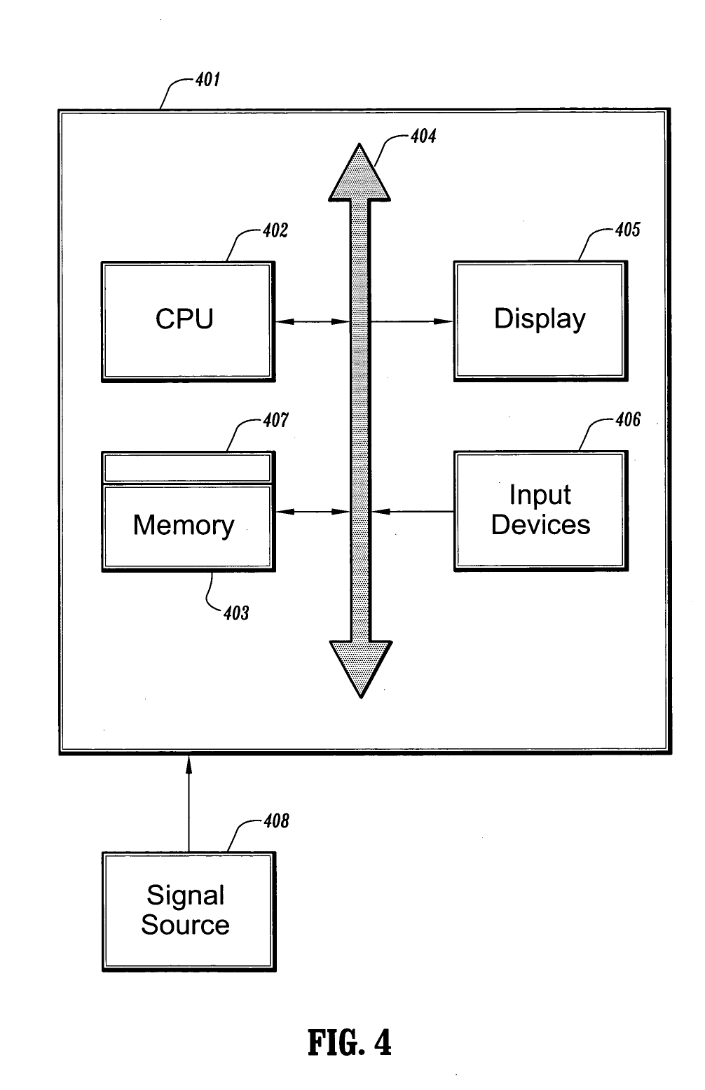

Referring now to FIG. 4, according to an embodiment of the present invention, a computer system 401 for implementing the present invention can comprise, inter alia, a central processing unit (CPU) 402, a memory 403 and an input/output (I/O) interface 404. The computer system 401 is generally coupled through the I/O interface 404 to a display 405 and various input devices 406 such as a mouse and a keyboard. The support circuits can include circuits such as cache, power supplies, clock circuits, and a communication bus. The memory 403 can include random access memory (RAM), read only memory (ROM), disk drive, tape drive, etc., or a combinations thereof. The present invention can be implemented as a routine 407 that is stored in memory 403 and executed by the CPU 402 to process the signal from the signal source 408. As such, the computer system 401 is a general purpose computer system that becomes a specific purpose computer system when executing the routine 407 of the present invention.

The computer system 401 also includes an operating system and micro instruction code. The various processes and functions described herein can either be part of the micro instruction code or part of the application program (or combination thereof) which is executed via the operating system. In addition, various other peripheral devices can be connected to the computer platform such as an additional data storage device and a printing device.

It is to be further understood that, because some of the constituent system components and method steps depicted in the accompanying figures can be implemented in software, the actual connections between the systems components (or the process steps) may differ depending upon the manner in which the present invention is programmed. Given the teachings of the present invention provided herein, one of ordinary skill in the related art will be able to contemplate these and similar implementations or configurations of the present invention.

The particular embodiments disclosed above are illustrative only, as the invention may be modified and practiced in different but equivalent manners apparent to those skilled in the art having the benefit of the teachings herein. Furthermore, no limitations are intended to the details of construction or design herein shown, other than as described in the claims below. It is therefore evident that the particular embodiments disclosed above may be altered or modified and all such variations are considered within the scope and spirit of the invention. Accordingly, the protection sought herein is as set forth in the claims below.

1. A method of identifying spherical objects in a digital image, wherein said image comprises a plurality of 3D surface points, said method comprising the steps of:
computing, at each point in a domain of the image, a gradient of the image;
computing an elementary structure tensor at each point in the domain of the image;
determining a structure tensor for each point in the domain of the image;
finding the eigenvalues of the structure tensors; and
analyzing said eigenvalues to determine the sphericity of a structure in said image.

2. The method of claim 1, wherein the gradient of the image is estimated by convolving the image with a derivative of a Gaussian kernel G of standard deviation σ_{G}, wherein σ_{G} is small relative to the size of the image.

3. The method of claim 1, wherein the elementary structure tensor can be defined by multiplying the gradient of an image with its transpose.

4. The method of claim 1, wherein the structure tensor can be determined by convolving the elementary structure tensor with a Gaussian kernel of standard deviation σ_{T}, wherein σ_{T} corresponds to the size of the object being sought.

5. The method of claim 1, wherein the eigenvalues are found by performing a Householder QL decomposition.

6. The method of claim 1, wherein the the eigenvalues are analyzed by dividing a smallest eigenvalue by a largest eigenvalue to calculate an isotropy measure, wherein the isotropy measure for a spherical object is equal to unity.

7. The method of claim 1, wherein the image is preprocessed.

8. A method of identifying spherical objects in a digital image, wherein said image comprises a plurality of intensities corresponding to a domain of points in a 3D space, said method comprising the steps of:
convolving the image with a derivative of a Gaussian kernel G of standard deviation σ_{G} to compute a gradient of the image at each point of the image, wherein σ_{G} is small relative to the size of the image;
multiplying the gradient for each point of the image with its transpose to compute an elementary structure tensor;
convolving the elementary structure tensor for each point with a Gaussian kernel of standard deviation σ_{T} to determine a structure tensor, wherein σ_{T} corresponds to the size of the object being sought;
performing a Householder QL decomposition of each structure tensor to find its eigenvalues; and
calculating an isotropy measure for each structure tensor, wherein said isotropy measure is defined by a ratio of a smallest eigenvalue of said structured tensor by a largest eigenvalue of said structure tensor, wherein a spherical object corresponds to an isotropy measure equal to unity.

9. The method of claim 8, wherein the image is preprocessed.

10. A program storage device readable by a computer, tangibly embodying a program of instructions executable by the computer to perform the method steps for identifying spherical objects in a digital image, wherein said image comprises a plurality of intensity values corresponding to a domain of points in a 3D space, said method comprising the steps of:
computing, at each point in the domain, a gradient of the image;
computing an elementary structure tensor at each point in the domain of the image;
determining a structure tensor for each point in the domain of the image;
finding the eigenvalues of the structure tensors; and
analyzing said eigenvalues to determine the sphericity of a structure in said image.

11. The computer readable program storage device of claim 10, the method steps further comprising estimating the gradient by convolving the image with a derivative of a Gaussian kernel G of standard deviation σ_{G} wherein σ_{G} is small relative to the size of the image.

12. The computer readable program storage device of claim 10, the method steps further comprising defining the elementary structure tensor by multiplying the gradient of an image with its transpose.

13. The computer readable program storage device of claim 10, the method steps further comprising determining the structure tensor by convolving the elementary structure tensor with a Gaussian kernel of standard deviation σ_{T} wherein σ_{T} corresponds to the size of the object being sought.

14. The computer readable program storage device of claim 10, the method steps further comprising performing a Householder QL decomposition to find the eigenvalues of the structure tensor.

15. The computer readable program storage device of claim 10, the method steps further comprising calculating an isotropy measure defined by dividing a smallest eigenvalue by a largest eigenvalue, wherein the isotropy measure for a spherical object is equal to unity.

16. The computer readable program storage device of claim 10, the method steps further comprising preprocessing the image.
